(19) United States
(12) Patent Application Publication
(10) Pub. No.: US 2021/0150289 A1
(43) Pub. Date: May 20, 2021

(54) TEXT CLASSIFICATION FOR INPUT METHOD EDITOR

(71) Applicant: Citrix Systems, Inc., Fort Lauderdale, FL (US)

(72) Inventors: Daowen WEI, Nanjing (CN); Jian DING, Nanjing (CN); Hengbo WANG, Nanjing (CN)

(21) Appl. No.: 16/731,386

(22) Filed: Dec. 31, 2019

Related U.S. Application Data
(63) Continuation of application No. PCT/CN2019/118468, filed on Nov. 14, 2019.

(51) Int. Cl. G06K 9/72; G06F 40/284; G06F 40/242

(52) U.S. Cl. CPC G06K 9/723; G06F 40/242; G06F 40/284

(57) ABSTRACT

Techniques are disclosed for an improved user interface, such as an input method editor (IME) that selectively collects text input based on text classification and user privacy preference. An example methodology implementing the techniques includes receiving, by the IME, at least one text input made by a user and, responsive to a determination that the at least one text input is a privacy word, causing the at least one text input to not be collected for learning usage habits of the user. The example method may also include, responsive to a determination that the at least one text input is not a privacy word, cause the at least one text input to be collected for learning usage habits of the user.

### CROSS REFERENCE TO RELATED APPLICATION

This application claims the benefit of PCT Patent Application No. PCT/CN2019/118468 filed on Nov. 14, 2019 in the English language in the State Intellectual Property Office, the contents of which are hereby incorporated herein by reference in its entirety.

### BACKGROUND

Electronic devices, such as mobile devices or other computing systems, often support various input method editors (IMEs). An IME is an operating system component or program that provides a specialized user interface, such as, for example, a soft keyboard through which a user may enter text characters, such as letters, numerical digits, punctuation marks, or words (generally referred to herein simply as “text input” or more simply “text”) into a mobile device or computing system. IMEs may collect text input that may be stored, and subsequently use the collected text input to provide autocomplete and/or next word suggestions. For example, when a user types the letters “pat” the autocomplete feature of the IME might suggest the word “patient” or “pattern” based upon previously collected text input via the IME. Furthermore, if a user enters a word, the IME may also predict the next word or words to be entered based upon the already entered word and previously collected text input and suggest the predicted word or words to the user for input to a mobile device or computing system through the IME.

### SUMMARY

This Summary is provided to introduce a selection of concepts in simplified form that are further described below in the Detailed Description. This Summary is not intended to identify key or essential features or combinations of the claimed subject matter, nor is it intended to be used to limit the scope of the claimed subject matter.

In accordance with one example embodiment provided to illustrate the broader concepts, systems, and techniques described herein, a method may include, in response to an input method editor (IME) receiving at least one text input, determining whether the at least one text input is a privacy word, responsive to a determination that the at least one text input is a privacy word, causing the IME to not collect the at least one word for learning usage habits, and responsive to a determination that the at least one text input is not a privacy word, causing the IME to collect the at least one word for learning usage habits.

In one aspect, the method may also include filtering out a stop word upon determining that the at least one text input includes the stop word.

In one aspect, determining whether the at least one text input is a privacy word comprises pattern matching the text input with known privacy patterns and, based upon results of the pattern matching, classifying the text input as one of: a privacy word or a neutral word.

In one aspect, determining that the at least one text input is a privacy word comprises performing text classification by performing a dictionary lookup.

In one aspect, determining that the at least one text input is a privacy word comprises performing text classification based upon a machine learning model.

According to another illustrative embodiment provided to illustrate the broader concepts described herein, a method may include receiving at least one word input to a user interface, determining a text category to which the at least one word belongs, determining whether the at least one word is a privacy word based on the determined text category and at least one privacy preference of the user, and, responsive to a determination that the at least one word is a privacy word, causing the at least one word to not be collected for learning usage habits of the user.

In one aspect, the method may also include, responsive to a determination that the at least one word is not a privacy word, causing the at least one word to be collected for learning usage habits of the user.

In one aspect, the at least one privacy preference includes at least one text category specified by the user as being private.

In one aspect, the at least one privacy preference includes at least one word specified by the user as being private.

In one aspect, the at least one word does not include a stop word.

In one aspect, determining a text category to which the at least one word belongs includes matching the at least one word to a privacy pattern.

In one aspect, determining a text category to which the at least one word belongs includes searching a dictionary for the at least one word, the dictionary including word-label pairs, wherein a word-label pair indicates a text category associated with a word.

In one aspect, determining a text category to which the at least one word belongs comprises determining a sequence of words based on the at least one word and determining a text category associated with the sequence of words using a machine learning model.

In one aspect, the sequence of words does not include a stop word.

In one aspect, the sequence of words does not include a privacy word.

In one aspect, the sequence of words includes a sequence of three words.

According to another illustrative embodiment provided to illustrate the broader concepts described herein, a system includes a memory and one or more processors in communication with the memory. The processor may be configured to receive at least one word input to a user interface by a user, responsive to a determination that the at least one word is a privacy word, cause the at least one word to not be collected for learning usage habits of the user, and, responsive to a determination that the at least one word is not a privacy word, cause the at least one word to be collected for learning usage habits of the user.

In one aspect, the determination that the at least one word is a privacy word is based on text classification of the at least one word and at least one privacy preference of the user.

In one aspect, the text classification is based on a hierarchical text classification workflow, the hierarchical text classification workflow includes one or more of a stop word filtering, a pattern matching, a dictionary lookup, and use of a machine learning model.

In one aspect, the at least one privacy preference includes at least one text category specified by the user as being private or at least one word specified by the user as being private.

### BRIEF DESCRIPTION OF THE DRAWINGS

The foregoing and other objects, features and advantages will be apparent from the following more particular description of the embodiments, as illustrated in the accompanying drawings in which like reference characters refer to the same parts throughout the different views. The drawings are not necessarily to scale, emphasis instead being placed upon illustrating the principles of the embodiments.

FIG. 1 depicts an illustrative computer system architecture that may be used in accordance with one or more illustrative aspects of the concepts described herein.

FIG. 2 depicts an illustrative remote-access system architecture that may be used in accordance with one or more illustrative aspects of the concepts described herein.

FIG. 3 is a schematic block diagram of a cloud computing environment in which various aspects of the disclosure may be implemented.

FIG. 4 is a block diagram illustrating selective components of an example computing device in which various aspects of the disclosure may be implemented, in accordance with an embodiment of the present disclosure.

FIG. 5 is a diagram illustrating an example text input processing workflow, in accordance with an embodiment of the present disclosure.

FIG. 6 is a diagram illustrating example privacy preference profiles, in accordance with an embodiment of the present disclosure.

FIG. 7 is a diagram illustrating an example hierarchical text classification workflow, in accordance with an embodiment of the present disclosure.

FIG. 8 is a diagram showing an example operation of a sliding window on a text input sequence, in accordance with an embodiment of the present disclosure.

FIG. 9 is a diagram illustrating an example text classification by a trained text classifier, in accordance with an embodiment of the present disclosure.

FIG. 10 is a diagram showing a construction of a trigram that does not include stop words or privacy words from a text input sequence, in accordance with an embodiment of the present disclosure.

FIG. 11 is a flow diagram illustrating an example process to classify text input, in accordance with an embodiment of the present disclosure.

### DETAILED DESCRIPTION

Autocomplete and/or predictive text features provided by conventional input method editors (IMEs) enhance user-computer interaction when such features correctly predict a word a user intends to enter after only a few characters have been typed into a text input field. This allows users of such IMEs to make fewer keystrokes to complete a word or a sentence, for example, when composing a text message, an email, and the like. Reducing the number of keystrokes may result in increased user-efficiency. Many conventional IMEs employ autocomplete algorithms that learn a user's typing or usage habits by collecting text or words that a user has previously entered. The autocomplete algorithm can then predict and suggest a next word or words based on the learned usage habits of the individual user. In order to provide increased user convenience and productivity, conventional IMEs collect information to learn user habits in interacting with the IMEs without regard to user privacy concerns. For example, a person may enter his or her government identification number (e.g., social security number) into a conventional IME with an expectation that the privacy of the input private data be maintained. However, conventional IMEs will collect the input private data for use in making subsequent predictions without regard to privacy concerns, thus exposing the collected private data to potential data breach or leakage.

Concepts, devices, and techniques are disclosed for an improved user interface, such as an improved IME that selectively collects text input based on text classification and user privacy preference. In an embodiment, a user may specify categories of words (or text) that the user considers private and is not to be collected and used by the IME in learning the user's usage habits. Then, when the user inputs text using the IME, the IME can perform text classification to determine a category to which the text input belongs and, based on the determined category, either collect the text input or not collect the text input for use in learning the user's usage habits. For example, and according to an embodiment, if the text input belongs to a category that the user specified as being private, the IME can consider the text input to be a privacy word and not collect the text input for use in learning the user's usage habits. Conversely, if the text input belongs to a category that the user did not specify as being private, the IME can consider the text input to be a neutral word and may collect the text input for use in learning the user's usage habits. In some embodiments, the user may specify specific words that the user considers private (i.e., that the user considers to be privacy words) and is not to be collected by the IME. As will be appreciated in light of this disclosure, the various embodiments of the improved IME provide a balance between user privacy protection and user convenience.

In more detail, and in accordance with an embodiment of the present disclosure, an improved IME is configured to apply a hierarchical text classification workflow to classify text input. In an embodiment, the workflow includes a hierarchy of text classification phases for determining whether a text input (e.g., a word or a sequence of words) is a privacy word or a neutral word. The first phase of the workflow includes a filtering operation where stop words are filtered out and not processed. The second phase of the workflow includes text classification using pattern matching. The third phase of the workflow includes text classification using dictionary lookup. The fourth phase of the workflow includes text classification using a machine learning model. The phases of the workflow are applied to text input in sequence to classify the text input as a privacy word or a neutral word. A next or higher phase in the workflow is applied to the text input only if the text input is classified as being a non-privacy word (neutral word) in the preceding phase. Note that the operation in a higher phase is computationally more expensive (i.e., computationally less efficient) relative to the operation at a lower phase. Also note that the computationally more expensive operations are only performed if the less expensive operations do not classify the text input as a privacy word. This provides a computationally efficient hierarchical text classification workflow suitable for implementing on all types of computing devices, including computing devices such as mobile devices which may have limited computing resources. These and other advantages, variations, and embodiments will be apparent in light of this disclosure.

As used herein, the term “text input” or more simply “text” refers to a sequence of one or more characters, such as letters, numerical digits, punctuation marks, and whitespace. The text may be a proper or actual word (e.g., a correctly spelled word such as “automobile”, “rabbit”, “apple”, “manual”, and “provocative”, to provide a few examples) or a non-word (e.g., an incorrectly spelled word or a sequence of characters such as “succ45”, “atomobil”, “qorie”, and “32 8”, to provide a few examples). The text may also be a sequence of one or more actual words and/or non-words.

As used herein, the term “text classification” refers broadly, in addition to its plain and ordinary meaning, to the process of categorizing text into organized groups. Text classification (also known as text categorization or text tagging) can therefore be understood as the task of assigning a predefined category or categories to text (e.g., a word or a sequence of words). Examples of text categories include sexuality, financial, locational, political, educational, medical, religious, science, sports, legal, disease, travel, entertainment, lifestyle, and humor, to provide a few examples.

As used herein, the term “privacy word” refers to text or a word or sequence of words that belongs to a text category that a user has specified to be private. For example, suppose that the user specifies political as a text category that is to be considered private and not collected by the IME. In this example, if the user inputs the word “liberal”, the IME may categorize the input text “liberal” as belonging to the text category political, which the user specified as being private. Accordingly, the IME can consider the text input “liberal” to be a privacy word and not collect the input text “liberal”. The term “privacy word” may also refer to specific words specified or otherwise indicated by a user to be private to the user. For example, the user may specify that the text “Alice” is a privacy word and which the IME is to consider private with respect to the user.

As used herein, the term “neutral word” refers to text or a word or sequence of words that belongs to a text category that a user has not specified to be private. Continuing the example above, if the user inputs the word “automobile”, the IME may categorize the word “automobile” as belonging to a text category “transportation object”, for example, which the user did not specify as being private (i.e., the word “automobile” is not categorized as belonging to the text category political). Accordingly, the IME can consider the input text “automobile” to be a neutral word and collect the input text “automobile” for use in learning the user's usage habits.

As used herein, the term “stop word” refers broadly, in addition to its plain and ordinary meaning, to short words that have little to no lexical meaning or have ambiguous meaning, and commonly express grammatical relationships among other words within a sentence. Stop words signal the structural relationships that words have to one another in a sentence. As such, stop words seldom or rarely disclose or divulge user privacy information. Examples of stop words include the words “a”, “an”, “to”, “be”, “the”, “is”, “at”, “which”, and “on”, to provide some examples.

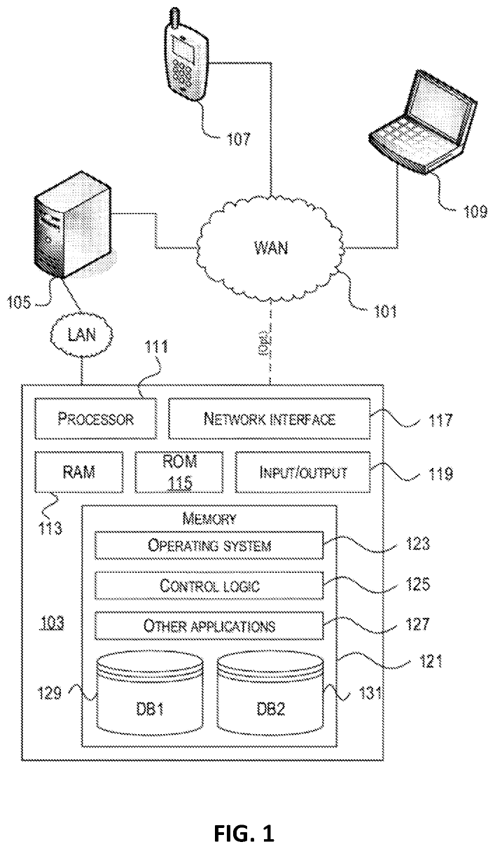

Computer software, hardware, and networks may be utilized in a variety of different system environments, including standalone, networked, remote-access (aka, remote desktop), virtualized, and/or cloud-based environments, among others. FIG. 1 illustrates one example of a system architecture and data processing device that may be used to implement one or more illustrative aspects of the concepts described herein in a standalone and/or networked environment. Various network node devices 103, 105, 107, and 109 may be interconnected via a wide area network (WAN) 101, such as the Internet. Other networks may also or alternatively be used, including private intranets, corporate networks, local area networks (LAN), metropolitan area networks (MAN), wireless networks, personal networks (PAN), and the like. Network 101 is for illustration purposes and may be replaced with fewer or additional computer networks. A local area network 133 may have one or more of any known LAN topologies and may use one or more of a variety of different protocols, such as Ethernet. Devices 103, 105, 107, and 109 and other devices (not shown) may be connected to one or more of the networks via twisted pair wires, coaxial cable, fiber optics, radio waves, or other communication media.

The term “network” as used herein and depicted in the drawings refers not only to systems in which remote storage devices are coupled together via one or more communication paths, but also to stand-alone devices that may be coupled, from time to time, to such systems that have storage capability. Consequently, the term “network” includes not only a “physical network” but also a “content network,” which is comprised of the data—attributable to a single entity—which resides across all physical networks.

The components and devices which make up the system of FIG. 1 may include a data server 103, a web server 105, and client computers 107, 109. Data server 103 provides overall access, control and administration of databases and control software for performing one or more illustrative aspects of the concepts described herein. Data server 103 may be connected to web server 105 through which users interact with and obtain data as requested. Alternatively, data server 103 may act as a web server itself and be directly connected to the Internet. Data server 103 may be connected to web server 105 through local area network 133, wide area network 101 (e.g., the Internet), via direct or indirect connection, or via some other network. Users may interact with data server 103 using remote computers 107, 109, e.g., using a web browser to connect to data server 103 via one or more externally exposed web sites hosted by web server 105. Client computers 107, 109 may be used in concert with data server 103 to access data stored therein or may be used for other purposes. For example, from client device 107 a user may access web server 105 using an Internet browser, as is known in the art, or by executing a software application that communicates with web server 105 and/or data server 103 over a computer network (such as the Internet).

Servers and applications may be combined on the same physical machines, and retain separate virtual or logical addresses, or may reside on separate physical machines. FIG. 1 illustrates just one example of a network architecture that may be used in the system architecture and data processing device of FIG. 1, and those of skill in the art will appreciate that the specific network architecture and data processing devices used may vary, and are secondary to the functionality that they provide, as further described herein. For example, services provided by web server 105 and data server 103 may be combined on a single server.

Each component 103, 105, 107, 109 may be any type of known computer, server, or data processing device. Data server 103, e.g., may include a processor 111 controlling overall operation of data server 103. Data server 103 may further include a random access memory (RAM) 113, a read only memory (ROM) 115, a network interface 117, input/output interfaces 119 (e.g., keyboard, mouse, display, printer, etc.), and a memory 121. Input/output (I/O) interfaces 119 may include a variety of interface units and drives for reading, writing, displaying, and/or printing data or files. Memory 121 may store operating system software 123 for controlling overall operation of the data server 103, control logic 125 for instructing data server 103 to perform aspects of the concepts described herein, and other application software 127 providing secondary, support, and/or other functionality which may or might not be used in conjunction with aspects of the concepts described herein. Control logic 125 may also be referred to herein as the data server software. Functionality of the data server software may refer to operations or decisions made automatically based on rules coded into the control logic, made manually by a user providing input into the system, and/or a combination of automatic processing based on user input (e.g., queries, data updates, etc.).

Memory 121 may also store data used in performance of one or more aspects of the concepts described herein. Memory 121 may include, for example, a first database 129 and a second database 131. In some embodiments, the first database may include the second database (e.g., as a separate table, report, etc.). That is, the information can be stored in a single database, or separated into different logical, virtual, or physical databases, depending on system design. Devices 105, 107, and 109 may have similar or different architecture as described with respect to data server 103. Those of skill in the art will appreciate that the functionality of data server 103 (or device 105, 107, or 109) as described herein may be spread across multiple data processing devices, for example, to distribute processing load across multiple computers, to segregate transactions based on geographic location, user access level, quality of service (QoS), etc.

One or more aspects of the concepts described here may be embodied as computer-usable or readable data and/or as computer-executable instructions, such as in one or more program modules, executed by one or more computers or other devices as described herein. Generally, program modules include routines, programs, objects, components, data structures, etc. that perform particular tasks or implement particular abstract data types when executed by a processor in a computer or other device. The modules may be written in a source code programming language that is subsequently compiled for execution or may be written in a scripting language such as (but not limited to) Hypertext Markup Language (HTML) or Extensible Markup Language (XML). The computer executable instructions may be stored on a computer readable storage medium such as a nonvolatile storage device. Any suitable computer readable storage media may be utilized, including hard disks, CD-ROMs, optical storage devices, magnetic storage devices, and/or any combination thereof. In addition, various transmission (non-storage) media representing data or events as described herein may be transferred between a source node and a destination node (e.g., the source node can be a storage or processing node having information stored therein which information can be transferred to another node referred to as a “destination node”). The media can be transferred in the form of electromagnetic waves traveling through signal-conducting media such as metal wires, optical fibers, and/or wireless transmission media (e.g., air and/or space). Various aspects of the concepts described herein may be embodied as a method, a data processing system, or a computer program product. Therefore, various functionalities may be embodied in whole or in part in software, firmware, and/or hardware or hardware equivalents such as integrated circuits, field programmable gate arrays (FPGA), and the like. Particular data structures may be used to more effectively implement one or more aspects of the concepts described herein, and such data structures are contemplated within the scope of computer executable instructions and computer-usable data described herein.

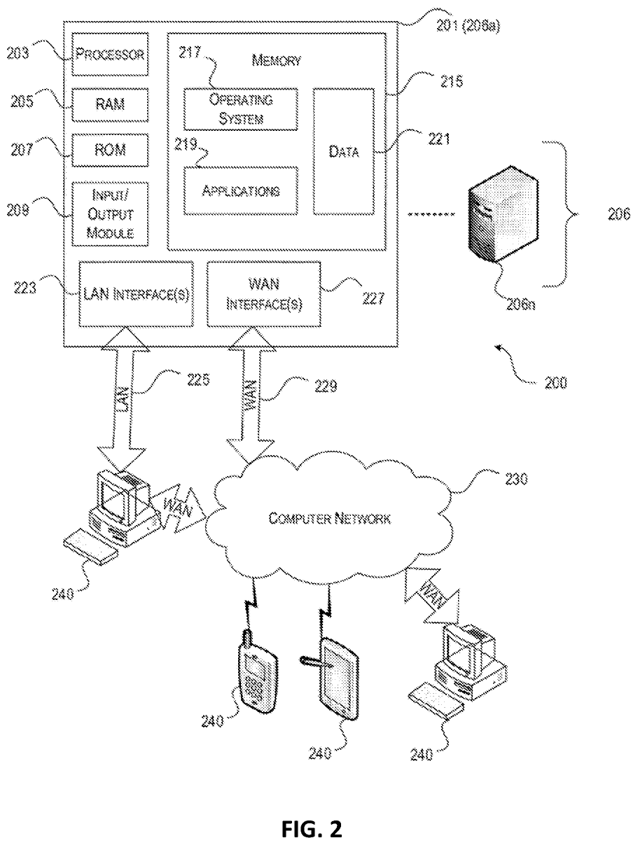

With further reference to FIG. 2, one or more aspects of the concepts described herein may be implemented in a remote-access environment. FIG. 2 depicts an example system architecture including a computing device 201 in an illustrative computing environment 200 that may be used according to one or more illustrative aspects of the concepts described herein. Computing device 201 may be used as a server 206a in a single-server or multi-server desktop virtualization system (e.g., a remote access or cloud system) configured to provide virtual machines (VMs) for client access devices. Computing device 201 may have a processor 203 for controlling overall operation of the server and its associated components, including a RAM 205, a ROM 207, an input/output (I/O) module 209, and a memory 215.

I/O module 209 may include a mouse, keypad, touch screen, scanner, optical reader, and/or stylus (or other input device(s)) through which a user of computing device 201 may provide input, and may also include one or more of a speaker for providing audio output and one or more of a video display device for providing textual, audiovisual, and/or graphical output. Software may be stored within memory 215 and/or other storage to provide instructions to processor 203 for configuring computing device 201 into a special purpose computing device in order to perform various functions as described herein. For example, memory 215 may store software used by the computing device 201, such as an operating system 217, application programs 219, and an associated database 221.

Computing device 201 may operate in a networked environment supporting connections to one or more remote computers, such as terminals 240 (also referred to as client devices). Terminals 240 may be personal computers, mobile devices, laptop computers, tablets, or servers that include many or all the elements described above with respect to data server 103 or computing device 201. The network connections depicted in FIG. 2 include a local area network (LAN) 225 and a wide area network (WAN) 229 but may also include other networks. When used in a LAN networking environment, computing device 201 may be connected to LAN 225 through an adapter or network interface 223. When used in a WAN networking environment, computing device 201 may include a modem or other wide area network interface 227 for establishing communications over WAN 229, such as to computer network 230 (e.g., the Internet). It will be appreciated that the network connections shown are illustrative and other means of establishing a communication link between the computers may be used. Computing device 201 and/or terminals 240 may also be mobile terminals (e.g., mobile phones, smartphones, personal digital assistants (PDAs), notebooks, etc.) including various other components, such as a battery, speaker, and antennas (not shown).

Aspects of the concepts described herein may also be operational with numerous other general purpose or special purpose computing system environments or configurations. Examples of other computing systems, environments, and/or configurations that may be suitable for use with aspects of the concepts described herein include, but are not limited to, personal computers, server computers, hand-held or laptop devices, multiprocessor systems, microprocessor-based systems, set top boxes, programmable consumer electronics, network personal computers (PCs), minicomputers, mainframe computers, distributed computing environments that include any of the above systems or devices, and the like.

As shown in FIG. 2, one or more terminals 240 may be in communication with one or more servers 206a-206n (generally referred to herein as “server(s) 206”). In one embodiment, computing environment 200 may include a network appliance installed between server(s) 206 and terminals 240. The network appliance may manage client/server connections, and in some cases can load balance client connections amongst a plurality of back-end servers 206.

Terminals 240 may in some embodiments be referred to as a single computing device or a single group of client computing devices, while server(s) 206 may be referred to as a single server 206 or a group of servers 206. In one embodiment, a single terminal 240 communicates with more than one server 206, while in another embodiment a single server 206 communicates with more than one terminal 240. In yet another embodiment, a single terminal 240 communicates with a single server 206.

Terminal 240 can, in some embodiments, be referred to as any one of the following non-exhaustive terms: client machine(s); client(s); client computer(s); client device(s); client computing device(s); local machine; remote machine; client node(s); endpoint(s); or endpoint node(s). Server 206, in some embodiments, may be referred to as any one of the following non-exhaustive terms: server(s), local machine; remote machine; server farm(s), or host computing device(s).

In one embodiment, terminal 240 may be a VM. The VM may be any VM, while in some embodiments the VM may be any VM managed by a Type 1 or Type 2 hypervisor, for example, a hypervisor developed by Citrix Systems, IBM, VMware, or any other hypervisor. In some aspects, the VM may be managed by a hypervisor, while in other aspects the VM may be managed by a hypervisor executing on server 206 or a hypervisor executing on terminal 240.

Some embodiments include a terminal, such as terminal 240, that displays application output generated by an application remotely executing on a server, such as server 206, or other remotely located machine. In these embodiments, terminal 240 may execute a VM receiver program or application to display the output in an application window, a browser, or other output window. In one example, the application is a desktop, while in other examples the application is an application that generates or presents a desktop. A desktop may include a graphical shell providing a user interface for an instance of an operating system in which local and/or remote applications can be integrated. Applications, as used herein, are programs that execute after an instance of an operating system (and, optionally, also the desktop) has been loaded.

Server 206, in some embodiments, uses a remote presentation protocol or other program to send data to a thin-client or remote-display application executing on the client to present display output generated by an application executing on server 206. The thin-client or remote-display protocol can be any one of the following non-exhaustive list of protocols: the Independent Computing Architecture (ICA) protocol developed by Citrix Systems, Inc. of Fort Lauderdale, Fla.; or the Remote Desktop Protocol (RDP) manufactured by Microsoft Corporation of Redmond, Wash.

A remote computing environment may include more than one server 206a-206n logically grouped together into a server farm 206, for example, in a cloud computing environment. Server farm 206 may include servers 206a-206n that are geographically dispersed while logically grouped together, or servers 206a-206n that are located proximate to each other while logically grouped together. Geographically dispersed servers 206a-206n within server farm 206 can, in some embodiments, communicate using a WAN, MAN, or LAN, where different geographic regions can be characterized as: different continents; different regions of a continent; different countries; different states; different cities; different campuses; different rooms; or any combination of the preceding geographical locations. In some embodiments, server farm 206 may be administered as a single entity, while in other embodiments server farm 206 can include multiple server farms.

In some embodiments, server farm 206 may include servers that execute a substantially similar type of operating system platform (e.g., WINDOWS, UNIX, LINUX, iOS, ANDROID, SYMBIAN, etc.) In other embodiments, server farm 206 may include a first group of one or more servers that execute a first type of operating system platform, and a second group of one or more servers that execute a second type of operating system platform.

Server 206 may be configured as any type of server, as needed, e.g., a file server, an application server, a web server, a proxy server, an appliance, a network appliance, a gateway, an application gateway, a gateway server, a virtualization server, a deployment server, a Secure Sockets Layer (SSL) VPN server, a firewall, a web server, an application server, a master application server, a server executing an active directory, or a server executing an application acceleration program that provides firewall functionality, application functionality, or load balancing functionality. Other server types may also be used.

Some embodiments include a first server 206a that receives requests from terminal 240, forwards the request to a second server 206b (not shown), and responds to the request generated by terminal 240 with a response from second server 206b (not shown). First server 206a may acquire an enumeration of applications available to terminal 240 as well as address information associated with an application server 206 hosting an application identified within the enumeration of applications. First server 206a can present a response to the client's request using a web interface and communicate directly with terminal 240 to provide terminal 240 with access to an identified application. One or more terminals 240 and/or one or more servers 206 may transmit data over network 230, e.g., network 101.

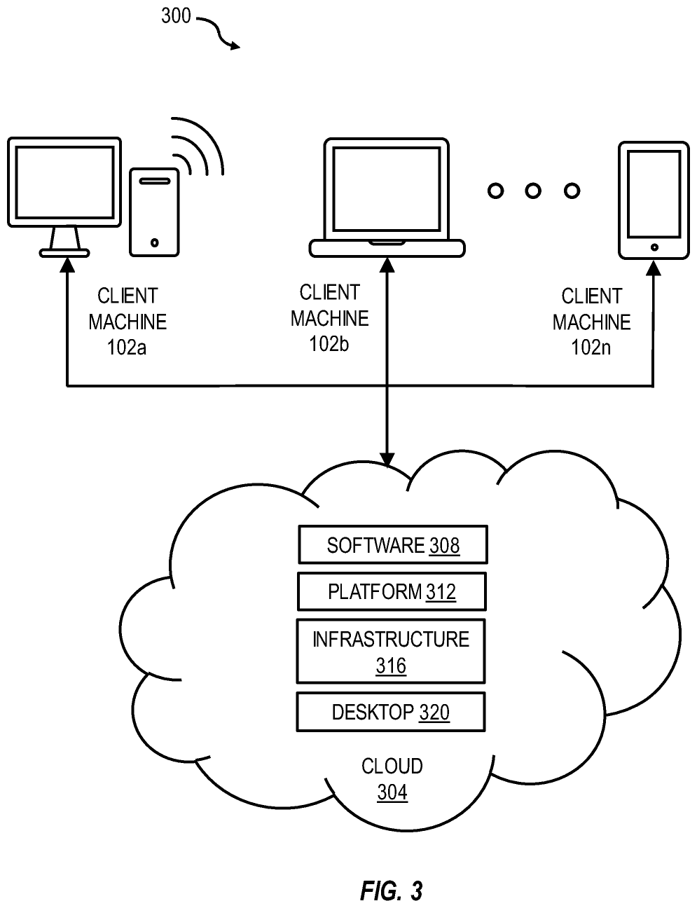

Referring to FIG. 3, a cloud computing environment 300 is depicted, which may also be referred to as a cloud environment, cloud computing or cloud network. Cloud computing environment 300 can provide the delivery of shared computing services and/or resources to multiple users or tenants. For example, the shared resources and services can include, but are not limited to, networks, network bandwidth, servers, processing, memory, storage, applications, virtual machines, databases, software, hardware, analytics, and intelligence.

In cloud computing environment 300, one or more clients 102a-102n (such as those described above) are in communication with a cloud network 304. Cloud network 304 may include back-end platforms, e.g., servers, storage, server farms or data centers. The users or clients 102a-102n can correspond to a single organization/tenant or multiple organizations/tenants. More particularly, in one example implementation cloud computing environment 300 may provide a private cloud serving a single organization (e.g., enterprise cloud). In another example, cloud computing environment 300 may provide a community or public cloud serving multiple organizations/tenants.

In some embodiments, a gateway appliance(s) or service may be utilized to provide access to cloud computing resources and virtual sessions. By way of example, Citrix Gateway, provided by Citrix Systems, Inc., may be deployed on-premises or on public clouds to provide users with secure access and single sign-on to virtual, SaaS and web applications. Furthermore, to protect users from web threats, a gateway such as Citrix Secure Web Gateway may be used. Citrix Secure Web Gateway uses a cloud-based service and a local cache to check for URL reputation and category.

In still further embodiments, cloud computing environment 300 may provide a hybrid cloud that is a combination of a public cloud and a private cloud. Public clouds may include public servers that are maintained by third parties to clients 102a-102n or the enterprise/tenant. The servers may be located off-site in remote geographical locations or otherwise.

Cloud computing environment 300 can provide resource pooling to serve multiple users via clients 102a-102n through a multi-tenant environment or multi-tenant model with different physical and virtual resources dynamically assigned and reassigned responsive to different demands within the respective environment. The multi-tenant environment can include a system or architecture that can provide a single instance of software, an application or a software application to serve multiple users. In some embodiments, cloud computing environment 300 can provide on-demand self-service to unilaterally provision computing capabilities (e.g., server time, network storage) across a network for multiple clients 102a-102n. By way of example, provisioning services may be provided through a system such as Citrix Provisioning Services (Citrix PVS). Citrix PVS is a software-streaming technology that delivers patches, updates, and other configuration information to multiple virtual desktop endpoints through a shared desktop image. Cloud computing environment 300 can provide an elasticity to dynamically scale out or scale in response to different demands from one or more clients 102. In some embodiments, cloud computing environment 300 can include or provide monitoring services to monitor, control and/or generate reports corresponding to the provided shared services and resources.

In some embodiments, cloud computing environment 300 may provide cloud-based delivery of different types of cloud computing services, such as Software as a service (SaaS) 308, Platform as a Service (PaaS) 312, Infrastructure as a Service (IaaS) 316, and Desktop as a Service (DaaS) 320, for example. IaaS may refer to a user renting the use of infrastructure resources that are needed during a specified time period. IaaS providers may offer storage, networking, servers or virtualization resources from large pools, allowing the users to quickly scale up by accessing more resources as needed. Examples of laaS include AMAZON WEB SERVICES provided by Amazon.com, Inc., of Seattle, Wash., RACKSPACE CLOUD provided by Rackspace US, Inc., of San Antonio, Tex., Google Compute Engine provided by Google Inc. of Mountain View, Calif., or RIGHTSCALE provided by RightScale, Inc., of Santa Barbara, Calif.

PaaS providers may offer functionality provided by IaaS, including, e.g., storage, networking, servers or virtualization, as well as additional resources such as, e.g., the operating system, middleware, or runtime resources. Examples of PaaS include WINDOWS AZURE provided by Microsoft Corporation of Redmond, Wash., Google App Engine provided by Google Inc., and HEROKU provided by Heroku, Inc. of San Francisco, Calif.

SaaS providers may offer the resources that PaaS provides, including storage, networking, servers, virtualization, operating system, middleware, or runtime resources. In some embodiments, SaaS providers may offer additional resources including, e.g., data and application resources. Examples of SaaS include GOOGLE APPS provided by Google Inc., SALESFORCE provided by Salesforce.com Inc. of San Francisco, Calif., or OFFICE 365 provided by Microsoft Corporation. Examples of SaaS may also include data storage providers, e.g. Citrix ShareFile from Citrix Systems, DROPBOX provided by Dropbox, Inc. of San Francisco, Calif., Microsoft SKYDRIVE provided by Microsoft Corporation, Google Drive provided by Google Inc., or Apple ICLOUD provided by Apple Inc. of Cupertino, Calif.

Similar to SaaS, DaaS (which is also known as hosted desktop services) is a form of virtual desktop infrastructure (VDI) in which virtual desktop sessions are typically delivered as a cloud service along with the apps used on the virtual desktop. Citrix Cloud from Citrix Systems is one example of a DaaS delivery platform. DaaS delivery platforms may be hosted on a public cloud computing infrastructure such as AZURE CLOUD from Microsoft Corporation of Redmond, Wash. (herein “Azure”), or AMAZON WEB SERVICES provided by Amazon.com, Inc., of Seattle, Wash. (herein “AWS”), for example. In the case of Citrix Cloud, Citrix Workspace app may be used as a single-entry point for bringing apps, files and desktops together (whether on-premises or in the cloud) to deliver a unified experience.

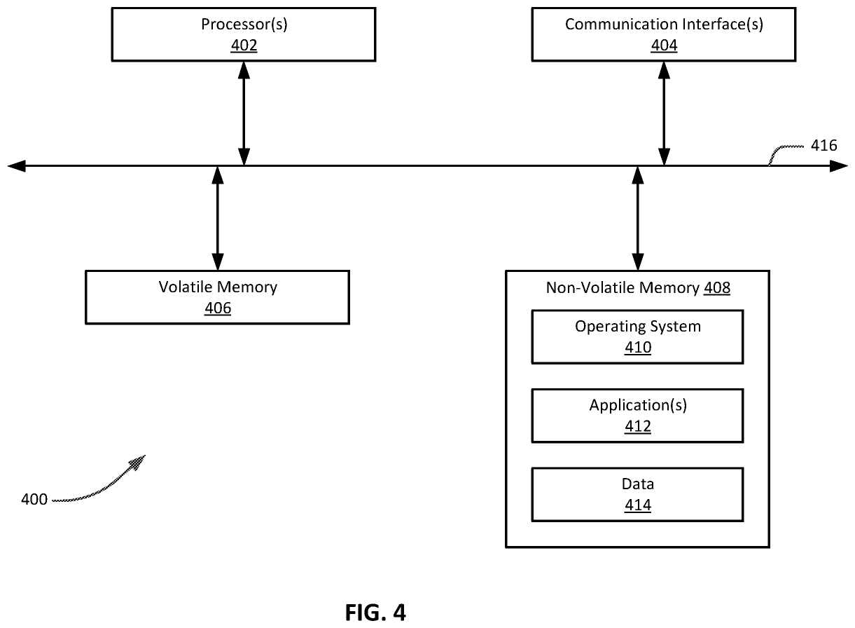

FIG. 4 is a block diagram illustrating selective components of an example computing device 400 in which various aspects of the disclosure may be implemented, in accordance with an embodiment of the present disclosure. Computing device 400 is shown merely as an example of components 105, 107, and 109 of FIG. 1, terminals 240 of FIG. 2, and/or client machines 102a-102n of FIG. 3, for instance. However, the illustrated computing device 400 is shown merely as an example and one skilled in the art will appreciate that components 105, 107, and 109 of FIG. 1, terminals 240 of FIG. 2, and/or client machines 102a-102n of FIG. 3 may be implemented by any computing or processing environment and with any type of machine or set of machines that may have suitable hardware and/or software capable of operating as described herein.

As shown in FIG. 4, computing device 400 includes one or more processor(s) 402, one or more communication interface(s) 404, a volatile memory 406 (e.g., random access memory (RAM)), a non-volatile memory 408, and a communications bus 416.

Non-volatile memory 408 may include: one or more hard disk drives (HDDs) or other magnetic or optical storage media; one or more solid state drives (SSDs), such as a flash drive or other solid-state storage media; one or more hybrid magnetic and solid-state drives; and/or one or more virtual storage volumes, such as a cloud storage, or a combination of such physical storage volumes and virtual storage volumes or arrays thereof.

Non-volatile memory 408 stores an operating system 410, one or more applications 412, and data 414 such that, for example, computer instructions of operating system 410 and/or applications 412 are executed by processor(s) 402 out of volatile memory 406. For example, in some embodiments, applications 412 may cause computing device 400 to implement functionality in accordance with the various embodiments and/or examples described herein. In some embodiments, volatile memory 406 may include one or more types of RAM and/or a cache memory that may offer a faster response time than a main memory. Data may be entered using an input device of computing device 400 or received from I/O device(s) communicatively coupled to computing device 400. Various elements of computing device 400 may communicate via communications bus 416.

Processor(s) 402 may be implemented by one or more programmable processors to execute one or more executable instructions, such as applications 412 and/or a computer program, to perform the functions of the system. As used herein, the term “processor” describes circuitry that performs a function, an operation, or a sequence of operations. The function, operation, or sequence of operations may be hard coded into the circuitry or soft coded by way of instructions held in a memory device and executed by the circuitry. A processor may perform the function, operation, or sequence of operations using digital values and/or using analog signals.

In some embodiments, processor 402 can be embodied in one or more application specific integrated circuits (ASICs), microprocessors, digital signal processors (DSPs), graphics processing units (GPUs), microcontrollers, field programmable gate arrays (FPGAs), programmable logic arrays (PLAs), multi-core processors, or general-purpose computers with associated memory.

Processor 402 may be analog, digital or mixed signal. In some embodiments, processor 402 may be one or more physical processors, or one or more virtual (e.g., remotely located or cloud computing environment) processors. A processor including multiple processor cores and/or multiple processors may provide functionality for parallel, simultaneous execution of instructions or for parallel, simultaneous execution of one instruction on more than one piece of data.

Communication interface(s) 404 may include one or more interfaces to enable computing device 400 to access a computer network such as a Local Area Network (LAN), a Wide Area Network (WAN), a Personal Area Network (PAN), or the Internet through a variety of wired and/or wireless connections, including cellular connections.

In described embodiments, computing device 400 may execute an application on behalf of a user of a client device. For example, computing device 400 may execute one or more virtual machines managed by a hypervisor. Each virtual machine may provide an execution session within which applications execute on behalf of a user or a client device, such as a hosted desktop session. Computing device 400 may also execute a terminal services session to provide a hosted desktop environment. Computing device 400 may provide access to a remote computing environment including one or more applications, one or more desktop applications, and one or more desktop sessions in which one or more applications may execute.

For example, in some embodiments, a first computing device 400 may execute an application on behalf of a user of a client computing device (e.g., client 107 or 109 of FIG. 1), may execute a VM, which provides an execution session within which applications execute on behalf of a user or a client computing device (e.g., any of client machines 102a-102n of FIG. 3), such as a hosted desktop session, may execute a terminal services session to provide a hosted desktop environment, or may provide access to a computing environment including one or more of: one or more applications, one or more desktop applications, and one or more desktop sessions in which one or more applications may execute.

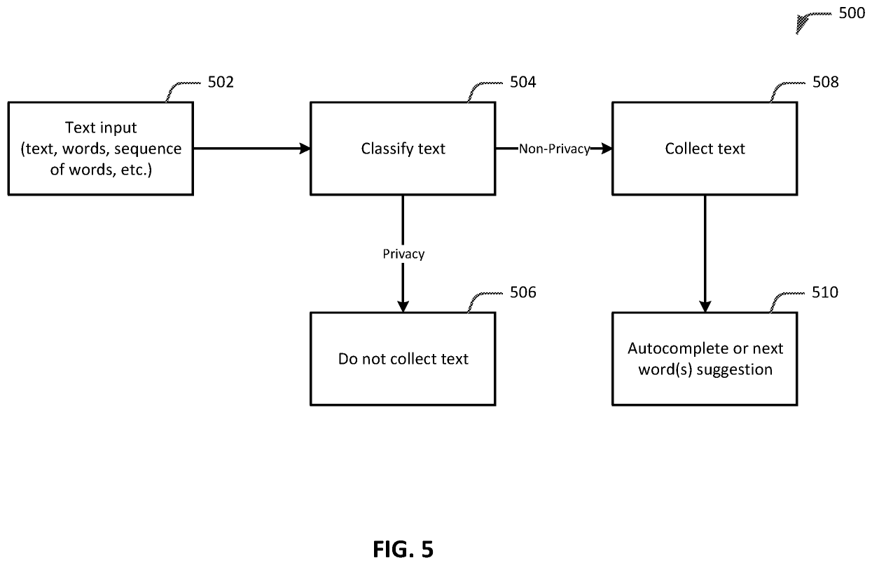

FIG. 5 illustrates an example text input processing workflow 500, in accordance with an embodiment of the present disclosure. In an embodiment, workflow 500 may be performed by an IME to selectively collect text input made by a user. The collected text input may then be used to learn the user's typing or usage habits. Based on the learned usage habits of the user, the IME may then make autocomplete and/or next word suggestions to the user while protecting the privacy of the user. With reference to workflow 500, text input (502) is received by or otherwise provided to the IME. In an example scenario, a user may be using the IME running on the user's mobile device to compose and send an electronic message, such as a short message service (SMS) message. To secure and/or protect the user's privacy, the user may have specified to the IME categories of text the user considers to be private. In an implementation, the categories of text may be specified in a privacy preference profile of or otherwise associated with the user. The user's privacy preference profile may be used by the IME to appropriately provide its convenience features, such as autocomplete and next word suggestion, while protecting the privacy of the user. In response to the text input (502) by the user, the IME can classify the text input (504) to determine a category to which the text input belongs. Based on the text classification and the text categories specified by the user as being private (e.g., the categories of text specified in the user's privacy preference profile), the IME can make a determination as to whether the text input is a privacy word or a non-privacy (neutral) word.

The IME does not collect the text input (506) if the IME determines that the text input is a privacy word. In other words, the IME does not collect text input by a user whose category is specified in the user's privacy preference profile. As a result, the text input (i.e., the text not collected by the IME) is not used to learn the user's usage habits in using the IME. Also, when the user subsequently uses the IME, the text not collected by the IME is neither predicted nor recommended by the IME for use by the user. Conversely, the IME collects the text input (508) if the IME determines that the text input is a non-privacy word (neutral word). When the user subsequently uses the IME, the collected text may be used by the IME to make autocomplete and next word suggestions to the user (510).

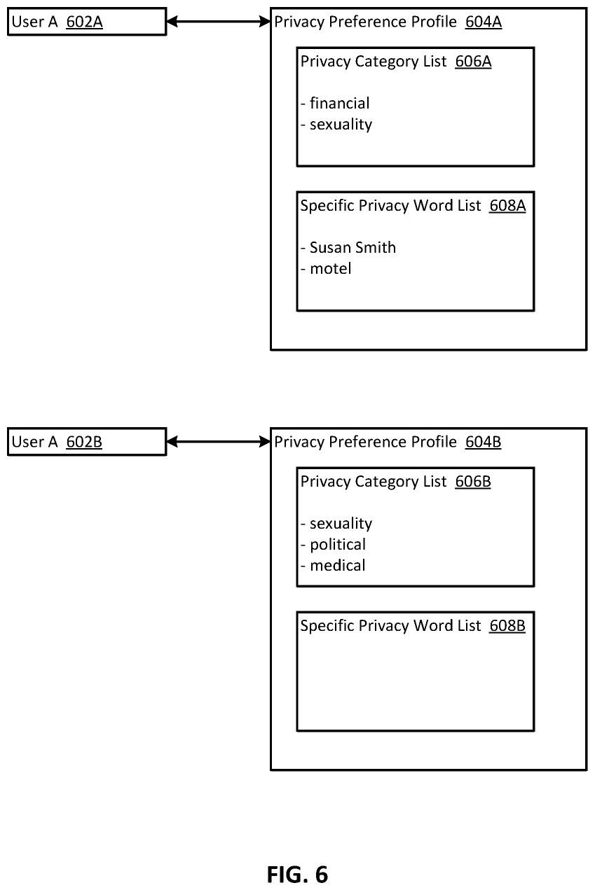

FIG. 6 is a diagram illustrating example privacy preference profiles, in accordance with an embodiment of the present disclosure. For example, and in an implementation, a user of an IME may generate a privacy preference profile for use by the IME. The privacy preference profiles may include information regarding a user's privacy preferences with respect to the user's use of the IME. A user's privacy preference profile may include a privacy category list that lists the text categories specified by the user as being private. In an embodiment, a user's privacy preference profile may optionally include a specific privacy word list that lists the specific words specified by the user as being private. In such embodiments where a user's privacy preference profile includes specific privacy words, the IME may not collect text input by a user if the text matches a privacy word specified in the specific privacy word list.

As can be seen in FIG. 6, a User A 602A may have generated a privacy preference profile 604A, which includes a privacy category list 606A and an optional specific privacy word list 608A, and a User B 602B may have generated a privacy preference profile 604B, which includes a privacy category list 606B and an optional specific privacy word list 608B. With respect to privacy preference profile 604A, User A 602A may have specified the text categories financial and sexuality to be private as indicated in privacy category list 606A. User A 602A may have also specified the specific words “Susan Smith” and “motel” to be private as indicated in specific privacy word list 608A. Note that a word in specific privacy word list 608A may be composed of one or more words (e.g., “Susan Smith” is actually two words “Susan” and “Smith”). With respect to privacy preference profile 604B, User B 602BA may have specified the text categories sexuality, political, and medical to be private as indicated in privacy category list 606B. Unlike User A 602A, User B 602B may not have specified any specific words to be private as indicated by the empty specific privacy word list 608B. While only two privacy preference profiles 604A and 604B are depicted in FIG. 6 for purposes of clarity, it will be understood that any number of privacy preference profiles may be maintained and used by the IME.

In some embodiments, a privacy preference profile may be generated and maintained for a group of users. For example, the parents in a family may generate a privacy preference profile for use by the IME. In this example case, upon identifying a user as one of the parents, the IME may use the information from the privacy preference profile to determine whether or not to collect text input to learn the usage habits of the user.

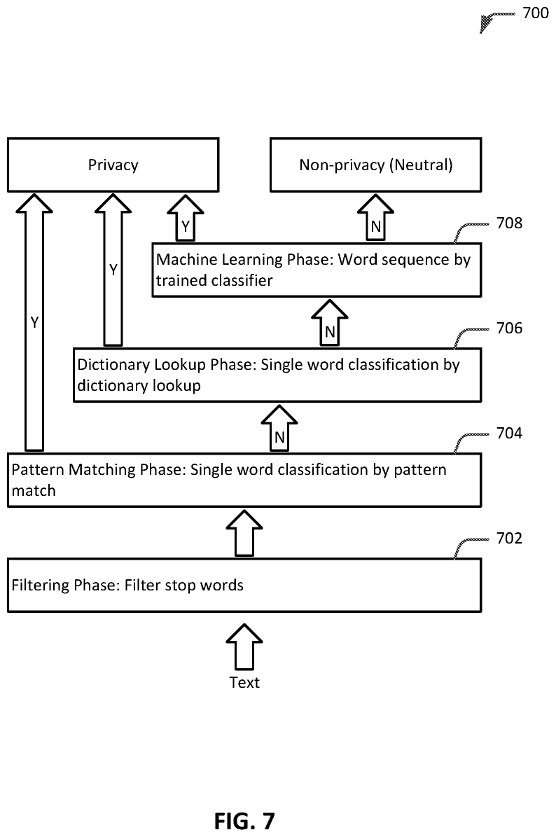

FIG. 7 is a diagram illustrating an example hierarchical text classification workflow 700, in accordance with an embodiment of the present disclosure. For example, as variously described as one example throughout this disclosure, an IME may apply workflow 700 to classify text input to the IME. As shown in FIG. 7, workflow 700 includes a hierarchy of text classification phases including a filtering phase 702, a pattern matching phase 704, a dictionary lookup phase 706, and a machine learning phase 708.

Filtering phase 702 includes filtering stop words from the text input. Input text that is identified to be a stop word is filtered out and not classified or processed since such words have little to no lexical meaning or have ambiguous meaning. Stop words include words such as, for example, “a”, “an”, “to”, “be”, “the”, “is”, “at”, “which”, and “on”, to provide some examples.

Patterning matching phase 704 includes matching the text input to known privacy patterns. These privacy patterns include pre-existing or known patterns of text associated with information commonly considered to be private. Examples such private information include identification information (e.g., government issued identification such as a passport number, a social security number, and other government issued identification number), salary information, credit card information, address (e.g., street address, city, state, zip code, and the like), and phone number, to provide a few examples. For example, credit card number can be represented using a privacy pattern “\d{4}\s\d{4}\s\d{4}\s\d{3}” (the string or sequence four digits, whitespace, four digits, whitespace, four digits, whitespace, three digits). In this example, if the text input matches the privacy pattern for a credit card, the text input may be determined to be a privacy word and not collected by the IME. Similarly, a social security number with hyphens can be represented using a privacy pattern “\d{3}-\d{2}-\d{4}” (e.g., 123-45-1234), and a 10-digit phone number with hyphens can be represented using a privacy pattern “\d{3}-\d{3}-\d{4}” (e.g., 123-555-1234). Note that the known privacy patterns may include patterns representing some of the example private information described above. Also note that the known privacy patterns may include patterns representing other types of private information that is not described above, including private information that may vary depending on geographical region. In any case, text input that matches a privacy pattern may be considered information that is private and/or sensitive to the user providing the text input and not collected by the IME.

In some embodiments, matching the text input to known privacy patterns may be by approximate string matching (also known as fuzzy string searching). In some embodiments, text input may be matched to known privacy patterns to determine a text category. For example, if the text input matches a privacy pattern representing a credit card number, a determination can be made that the text input belongs to a text category financial. In this example, if the user specified the text category financial as being private, then it can be determined that the text input is a privacy word and not collected by the IME. On the other hand, if the user did not specify the text category financial as being private, then it can be determined that the text input is a non-privacy word (neutral word) and collected by the IME.

Dictionary lookup phase 706 includes searching a dictionary to determine a text category to which the text input belongs. In an embodiment, the dictionary may be a privacy dictionary or repository that includes word-label pairs which indicates a text category associated with a particular word. For example, a word-label pair “{cancer, medical}” may indicate that the word “cancer” belongs to or is associated with the text category medical. Similarly, a word-label pair “{syphilis, medical}” may indicate that the word “syphilis” belongs to the text category medical. As another example, a word-label pair “{sexual, sexuality}” may indicate that the word “sexual” belongs to the text category sexuality. Upon determining a text category for a text input using the dictionary, a further determination can be made as to whether the text input is a privacy word based on the determined text category and the text categories specified by the user as being private. If the text category determined from the dictionary lookup is one of the text categories specified by the user as being private, it can be determined that the text input is a privacy word and not collected by the IME. On the other hand, if the text category determined from the dictionary lookup is not one of the text categories specified by the user as being private, then it can be determined that the text input is a non-privacy word (neutral word) and collected by the IME. Note that in some cases, depending on the robustness of the dictionary, the dictionary may not include a word-label pair for a text input. In such cases, dictionary lookup phase 706 may not result in a determination of a text category for the text input. In some embodiments, the dictionary may be a global dictionary, such as a dictionary that is provided and maintained in the cloud. In some embodiments, the dictionary may be a local dictionary in the sense that the dictionary is on the computing device on which the IME is running. For example, the dictionary, such as a remote or global dictionary, may be downloaded onto the computing device on which the IME is executing.

Machine learning phase 708 includes utilizing a text classification model to make text category predictions. The text classification model may be generated by training a suitable machine learning algorithm, such as, n-gram, fastText, Convolutional Neural Network for Text Classification (TextCNN), Recurrent Neural Network for Text Classification (TextRNN), Recurrent Convolutional Neural Network for Text Classification (RCNN), and Hierarchical Attention Network, to name a few examples. Machine learning phase 708 may be applied to the text input based on the premise that individual words may not be indicative of a user's privacy concerns. In other words, individual words may not reveal or divulge information that may be private and/or sensitive to the user. However, taken in the aggregate, a sequence or combination of words may be indicative of a user's privacy concerns. For example, the individual words, such as “far”, “right”, and “activist”, may be considered neutral words that are not related to any privacy concerns of a user. However, taken in the aggregate, the sequence of words “far right activist” may reveal or divulge a user's political viewpoints.

In an embodiment, the training samples used in training the machine learning algorithm may be based on a trigram model, wherein training samples include a sequence of three words (a trigram) and a label. Here, the label serves as a ground truth indicating a text classification to which the sequence of three words belongs. The concept of an n-gram model is well understood in the fields of probability and computational linguistics, including natural language processing and machine learning, and will not be discussed in detail here. However, for purposes of this discussion, it is sufficient to understand that an n-gram model models sequences of words, notably natural languages, using statistical properties of n-grams. In particular, an n-gram model assumes words depend upon the last (n−1) words described in a Markov chain. Once trained on such training samples, the text classification model is able to predict a text category for an input sequence of three words. If the text category predicted by the text classification model is one of the text categories specified by the user as being private, it can be determined that the sequence of three words input to the text classification model is private and/or sensitive to the user (e.g., determined to be a privacy word). In such cases, the sequence of three words is not collected by the IME. On the other hand, if the text category predicted by the text classification model is not one of the text categories specified by the user as being private, then it can be determined that the sequence of three words input to the text classification model is not private and/or sensitive to the user (e.g., is a non-privacy word). In such cases, the sequence of three words is collected by the IME.

In some embodiments, the training samples used in training a machine learning algorithm may be based on an n-gram model or sequences of words that is different from a trigram model, such as a bigram model or any other suitable model, for example. In such embodiments, a sequence of words that is of a length that corresponds to the model used to train the machine learning algorithm may be input to the text classification model for predicting a text category for the input sequence of words.

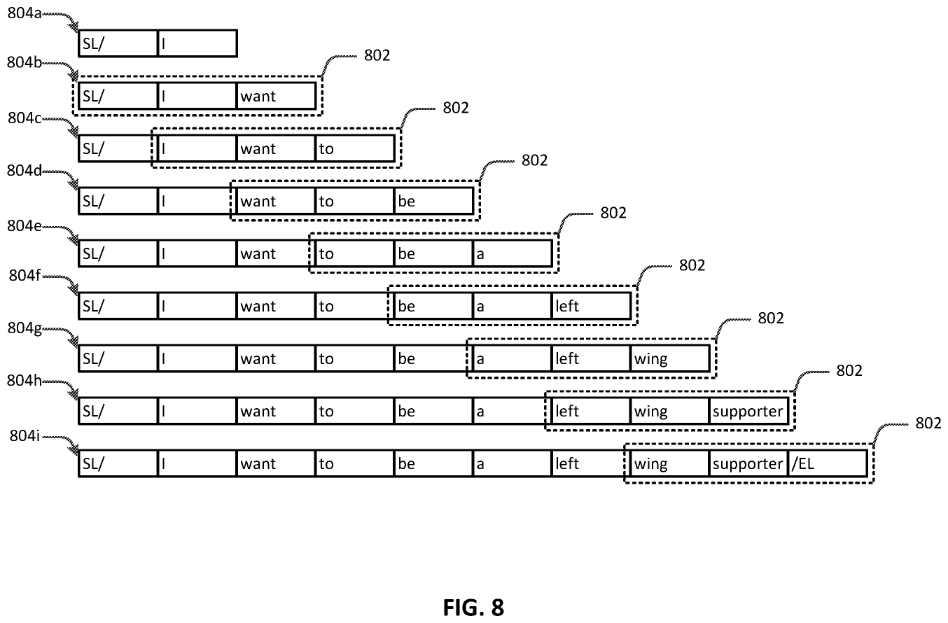

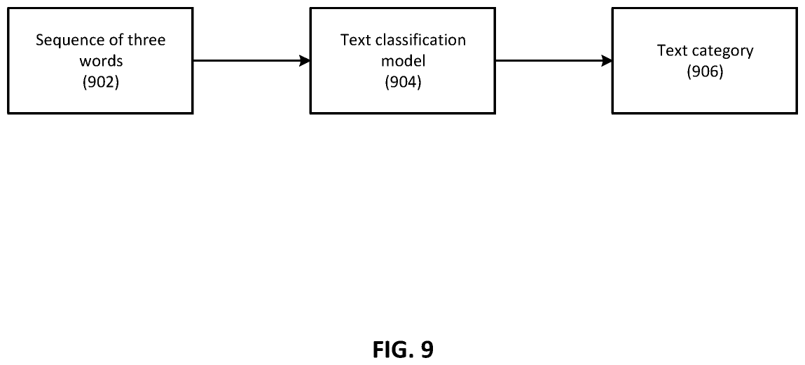

FIG. 8 is a diagram showing an example operation of a sliding window 802 on a text input sequence, in accordance with an embodiment of the present disclosure. In an example use scenario, a user may be using the IME to compose a text message that includes a sequence of words “I want to be a left wing supporter”. As shown in FIG. 8, sliding window 802 may operate on the text input to construct or otherwise generate trigrams (e.g., sequences of three words) as the text is being input to the IME by the user. A trigram generated using sliding window 802 includes a sequence of most recent three words input to the IME. In particular, sliding window 802 may begin with a start line marker (“SL/”) and operate by moving or sliding forward word-by-word until an end line marker (“/EL”) is detected. Sliding window 802 may begin operation upon the text input being of a sufficient number of words to generate a trigram. For example, as can be seen in FIG. 8, sliding window 802 does not operate when a text sequence 804a (the sequence “I” after the start line marker) is the text input. This is because text sequence 804a does not include a sufficient number of words to generate a trigram. Sliding window 802 may start to operate when a text sequence 804b is the text input and may continue to operate with text sequences 804c to 804i. For example, when the text input is sequence 804b, sliding window 802 may operate to indicate “SL/ I want” as the trigram. When the text input is sequence 804c, sliding window 802 may operate to slide forward one word to indicate “I want to” as the trigram. Sliding window 802 may operate to slide forward by one word for sequences 804d to 804i at which sliding window 802 may indicate “wing supporter EL/” as the trigram. Note that sliding window 802 need not include the start line marker (“SL/”) or the end line marker (“/EL”). For example, in some cases, sliding window 802 may start including the first word after the start line marker and not include the end line marker. In any case, as shown in FIG. 9, upon generating a trigram, the trigram (902) may be input or otherwise provided to the text classification model (904), and the model may predict a text category (906) to which the input trigram belongs.

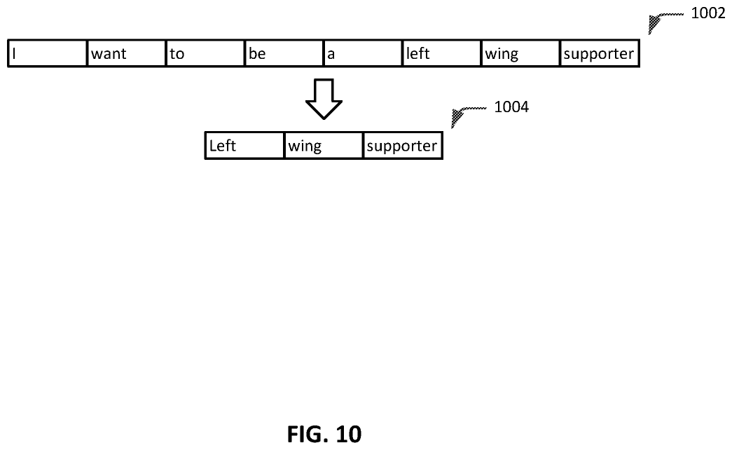

In some embodiments, the generated trigram may not include stop words or privacy words. For example, as can be seen in FIG. 10, a text sequence 1002 “I want to be a left wing supporter” may be processed using a sliding window, such as sliding window 802 of FIG. 8, to generate a trigram 1004 “left wing supporter”. Note that trigram 1004 does not include the stop words “I”, “want”, “to”, “be”, and “a” from text sequence 1002. To this end, when the user inputs the word “I” to the IME, a determination can be made that the word “I” is a stop word and be filtered from processing, for example in filtering phase 702 in cases where filtering phase 702 is implemented by the IME. Even in cases where filtering phase 702 may not be implemented by the IME, the IME can identify and filter out stop words such that the stop word is not included in the sliding window. In a similar manner, the IME can identify and filter out a privacy word that may have been input by the user such that the privacy word is not included in the sliding window and, thus, not included in the generated trigram. For example, when the user inputs a word to the IME, the input word may be matched to known privacy patterns (e.g., similar to the operation described above in conjunction with pattern matching phase 704 of FIG. 7) and/or searched for in a privacy dictionary (e.g., similar to the operation described above in conjunction with dictionary lookup phase 706 of FIG. 7) to determine whether the input word is a privacy word.

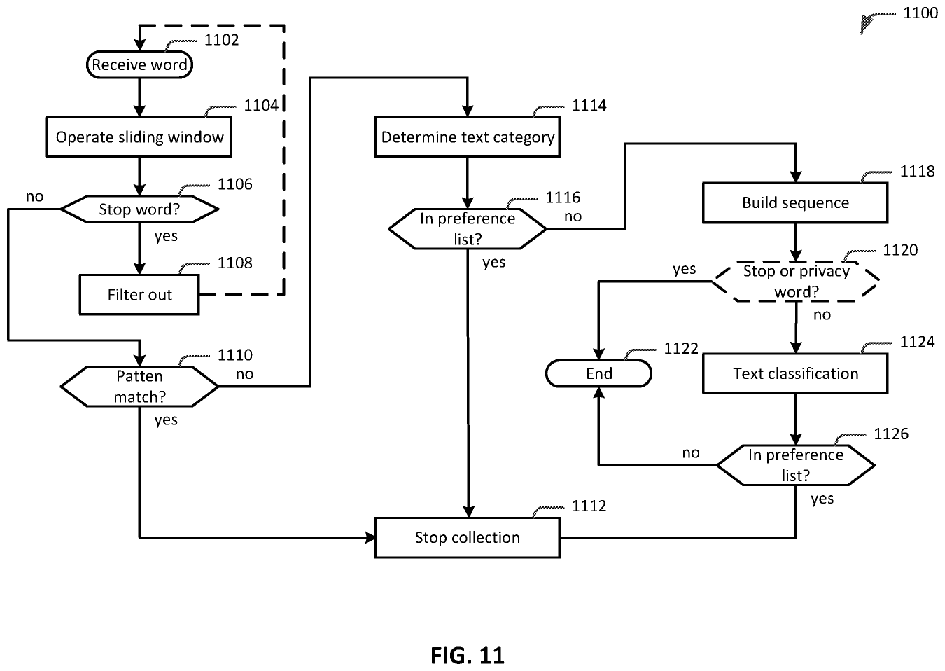

FIG. 11 is a flow diagram illustrating an example process 1100 to classify text input, in accordance with an embodiment of the present disclosure. The operations, functions, or actions illustrated in example process 1100 may be stored as computer-executable instructions in a computer-readable medium, such as volatile memory 406 and/or non-volatile memory 408 of computing device 400 of FIG. 4 (e.g., computer-readable medium of components 105, 107, and 109 of FIG. 1, terminals 240 of FIG. 2, and/or client machines 102a-102n of FIG. 3). In some embodiments, process 1100 may be implemented by an IME, which may run on a suitable computing device, such as computing device 400 of FIG. 4, components 105, 107, and 109 of FIG. 1, terminals 240 of FIG. 2, client machines 102a-102n of FIG. 3, and/or computing device 400 of FIG. 4. For example, the operations, functions, or actions described in the respective blocks of example process 1100 may be implemented by applications 412 and/or data 414 of computing device 400.

With reference to example process 1100 of FIG. 11, at operation 1102, the IME may receive a word input by a user. The word may be a part of text being input by the user. For example, the user may be using the IME to compose an email to a colleague or other recipient. At operation 1104, the IME may operate a sliding window, such as sliding window 802, over the received text input including the word just received. At operation 1106, the IME may check to determine whether the received word is a stop word. If the IME determines that the received word is a stop word, then, at operation 1108, the IME may filter out the received word, such that the received word is not processed. In an implementation, the IME may then return to operation 1102 to receive a next word input by the user. In some implementations, the IME may end processing of process 1100 upon determining that the received is a stop word.

Otherwise, if the IME determines that the received word is not a stop word, then, at operation 1110, the IME may perform a pattern match against known privacy patterns. If the IME determines that the received word matches any one of the known privacy patterns, the IME can conclude that the received word is a privacy word and, at operation 1112, not collect the received word. In an implementation, the IME may then return to operation 1102 to receive a next word input by the user.

If the IME determines that the received word does not match any one of the known privacy patterns, then, at operation 1114, the IME can determine a text category for the received word based on a match against entries (e.g., word-label pairs) in a privacy dictionary.

At operation 1116, the IME may check to determine whether the text category determined from the privacy dictionary lookup is one of the text categories specified by the user as being private. If the IME determines that the text category determined for the received word using the privacy dictionary is one of the text categories specified by the user as being private, the IME can conclude that the received word is a privacy word and, at operation 1112, not collect the received word. In an implementation, the IME may then return to operation 1102 to receive a next word input by the user.

Otherwise, if the IME determines that the text category determined for the received word using the privacy dictionary is not one of the text categories specified by the user as being private, then, at operation 1118, the IME may generate a sequence of words that includes the received word. For example, the sequence of words may be generated based on the operation of the sliding window (e.g., refer to operation 1104).

At operation 1120, the IME may check to determine whether the generated sequence of words includes a stop word or a privacy word. Note that operation 1120 is optional in that stop words and privacy words may have been filtered out at previous operations, for example, at operation 1108 and operation 1112, respectfully. As such, operation 1120 may be performed by IMEs that do not implement stop word filtering (e.g., operation 1106) and/or pattern matching (e.g., operation 1110). If the IME determines that the generated sequence of words includes a stop word or a privacy word, then, at operation 1122, the IME may end processing of process 1100. In an implementation, rather than end processing of process 1100, the IME may return to operation 1102 to receive a next word input by the user.

Otherwise, if the IME determines that the generated sequence of words does not include a stop word or a privacy word, then, at operation 1124, the IME may determine a text category for the generated sequence of words using a text classification model. At operation 1126, the IME may check to determine whether the text category predicted by the text classification model is one of the text categories specified by the user as being private. If the IME determines that the text category predicted by the text classification model is one of the text categories specified by the user as being private, the IME can conclude that the generated sequence of words is private and/or sensitive to the user (e.g., a privacy word) and, at operation 1112, not collect the generated sequence of words. In an implementation, the IME may then return to operation 1102 to receive a next word input by the user.

Otherwise, if the IME determines that the text category predicted by the text classification model is not one of the text categories specified by the user as being private, the IME can conclude that the generated sequence of words is not private and/or sensitive to the user (e.g., not a privacy word) and, at operation 1128, allow collection. For example, in an implementation, the IME may allow collection of the first word in the generated sequence of words. In other implementations, the IME may allow collection of multiple words in the generated sequence of words. Then, at operation 1122, the IME may then end processing of process 1100. In an implementation, rather than end processing of process 1100, the IME may return to operation 1102 to receive a next word input by the user.

In some embodiments, additional operations may be performed. For example, in implementations where the IME does not perform text classification using a text classification model (e.g., operation 1124), the IME may collect a received word upon determining that the received word is not a stop word (e.g., subsequent to operation 1106) or a privacy word. (e.g., subsequent to operation 1116).

As will be further appreciated in light of this disclosure, with respect to the processes and methods disclosed herein, the functions performed in the processes and methods may be implemented in differing order. Additionally or alternatively, two or more operations may be performed at the same time or otherwise in an overlapping contemporaneous fashion. Furthermore, the outlined actions and operations are only provided as examples, and some of the actions and operations may be optional, combined into fewer actions and operations, or expanded into additional actions and operations without detracting from the essence of the disclosed embodiments.

In the description of the various embodiments, reference is made to the accompanying drawings identified above and which form a part hereof, and in which is shown by way of illustration various embodiments in which aspects of the concepts described herein may be practiced. It is to be understood that other embodiments may be utilized, and structural and functional modifications may be made without departing from the scope of the concepts described herein. It should thus be understood that various aspects of the concepts described herein may be implemented in embodiments other than those specifically described herein. It should also be appreciated that the concepts described herein are capable of being practiced or being carried out in ways which are different than those specifically described herein.

As used in the present disclosure, the terms “engine” or “module” or “component” may refer to specific hardware implementations configured to perform the actions of the engine or module or component and/or software objects or software routines that may be stored on and/or executed by general purpose hardware (e.g., computer-readable media, processing devices, etc.) of the computing system. In some embodiments, the different components, modules, engines, and services described in the present disclosure may be implemented as objects or processes that execute on the computing system (e.g., as separate threads). While some of the system and methods described in the present disclosure are generally described as being implemented in software (stored on and/or executed by general purpose hardware), specific hardware implementations, firmware implements, or any combination thereof are also possible and contemplated. In this description, a “computing entity” may be any computing system as previously described in the present disclosure, or any module or combination of modulates executing on a computing system.

Terms used in the present disclosure and in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, such recitation should be interpreted to mean at least the recited number (e.g., the bare recitation of “two widgets,” without other modifiers, means at least two widgets, or two or more widgets). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc.

It is to be understood that the phraseology and terminology used herein are for the purpose of description and should not be regarded as limiting. Rather, the phrases and terms used herein are to be given their broadest interpretation and meaning. The use of “including” and “comprising” and variations thereof is meant to encompass the items listed thereafter and equivalents thereof as well as additional items and equivalents thereof. The use of the terms “connected,” “coupled,” and similar terms, is meant to include both direct and indirect, connecting, and coupling.

All examples and conditional language recited in the present disclosure are intended for pedagogical examples to aid the reader in understanding the present disclosure, and are to be construed as being without limitation to such specifically recited examples and conditions. Although example embodiments of the present disclosure have been described in detail, various changes, substitutions, and alterations could be made hereto without departing from the spirit and scope of the present disclosure. Accordingly, it is intended that the scope of the present disclosure be limited not by this detailed description, but rather by the claims appended hereto.

What is claimed is:

1. A method comprising:
in response to an input method editor (IME) receiving at least one text input, determining whether the at least one text input is a privacy word;
responsive to a determination that the at least one text input is a privacy word, causing the IME to not collect the at least one word for learning usage habits; and
responsive to a determination that the at least one text input is not a privacy word, causing the IME to collect the at least one word for learning usage habits.

2. The method of claim 1, further comprising filtering out a stop word upon determining that the at least one text input includes the stop word.

3. The method of claim 1, wherein determining whether the at least one text input is a privacy word comprises:
pattern matching the text input with known privacy patterns; and
based upon results of the pattern matching, classifying the text input as one of: a privacy word or a neutral word.

4. The method of claim 1, wherein determining that the at least one text input is a privacy word comprises performing text classification by performing a dictionary lookup.

5. The method of claim 1, wherein determining that the at least one text input is a privacy word includes performing text classification based upon a machine learning model.

6. A method comprising:
receiving at least one word input to a user interface;
determining a text category to which the at least one word belongs;
determining whether the at least one word is a privacy word based on the determined text category and at least one privacy preference of the user; and
responsive to a determination that the at least one word is a privacy word, causing the at least one word to not be collected for learning usage habits of the user.

7. The method of claim 6, further comprising, responsive to a determination that the at least one word is not a privacy word, causing the at least one word to be collected for learning usage habits of the user.

8. The method of claim 6, wherein the at least one privacy preference includes at least one text category specified by the user as being private.

9. The method of claim 6, wherein the at least one privacy preference includes at least one word specified by the user as being private.

10. The method of claim 6, wherein the at least one word does not include a stop word.

11. The method of claim 6, wherein determining a text category to which the at least one word belongs includes matching the at least one word to a privacy pattern.

12. The method of claim 6, wherein determining a text category to which the at least one word belongs includes searching a dictionary for the at least one word, the dictionary including word-label pairs, wherein a word-label pair indicates a text category associated with a word.

13. The method of claim 6, wherein determining a text category to which the at least one word belongs comprises:
determining a sequence of words based on the at least one word; and
determining a text category associated with the sequence of words using a machine learning model.

14. The method of claim 13, wherein the sequence of words does not include a stop word.

15. The method of claim 13, wherein the sequence of words does not include a privacy word.

16. The method of claim 13, wherein the sequence of words includes a sequence of three words.

17. A system comprising:
a memory; and
one or more processors in communication with the memory and configured to, receive at least one word input to a user interface by a user;
responsive to a determination that the at least one word is a privacy word, cause the at least one word to not be collected for learning usage habits of the user; and
responsive to a determination that the at least one word is not a privacy word, cause the at least one word to be collected for learning usage habits of the user.

18. The system of claim 17, wherein the determination that the at least one word is a privacy word is based on text classification of the at least one word and at least one privacy preference of the user.

19. The system of claim 18, wherein the text classification is based on a hierarchical text classification workflow, the hierarchical text classification workflow includes one or more of a stop word filtering, a pattern matching, a dictionary lookup, and use of a machine learning model.

20. The system of claim 18, wherein the at least one privacy preference includes at least one text category specified by the user as being private or at least one word specified by the user as being private.
